(19) United States
(12) Patent Application Publication
(10) Pub. No.: US 2006/0261957 A1
(43) Pub. Date: Nov. 23, 2006

(54) Method for producing bridge modules

(76) Inventor: Ralf God, Dresden (DE)

Correspondence Address: BLACK LOWE & GRAHAM, PLLC, 701 FIFTH AVENUE, SUITE 4800, SEATTLE, WA, 98104, US

(21) Appl. No.: 10/569,759

(22) PCT Filed: Aug. 24, 2004
(86) PCT No.: PCT/EP04/09421

§ 371 Date: Feb. 24, 2006

(30) Foreign Application Priority Data
Aug. 26, 2003 (DE) 10339547.4
Dec. 13, 2003 (DE) 10358422.6

(51) Int. Cl. G08B 13/14

(52) U.S. Cl. 340/572.8

(57) ABSTRACT

The invention relates to a method for producing module bridges (29) for smart labels for positioning chip modules (25) on carriers (31) and for the bridging, conductive connection of connection elements of the chip modules (25) to connection elements (30a, 30b) of antenna elements (30) arranged on or in the carriers (31), comprising the following steps:
forming (2) depressions (22) arranged one behind the other within an endless carrier strip (21) which can be moved in the longitudinal direction;
positioning (4) a respective chip module (25) in each depression (22) with connection elements pointing upwards; and
printing (8) strip-like contact layers (27a, 27b) to the connection elements of the chip modules (25) and a surface of the carrier strip (21) next to the depressions (22), so as to form enlarged contact areas.

The invention relates to a method for producing module bridges for smart labels for positioning chip modules on carriers and for the bridging, conductive connection of connection elements of the chip modules to connection elements of antenna elements arranged on or in the carriers, according to the preamble of claim 1.

The manufacture of smart labels includes inter alia the arrangement of an RFID (Radio Frequency Identification chip), which is usually a silicon chip, on connection elements of an antenna element and an antenna substrate which carries the antenna element. Such antenna substrates may be for example films, labels or relatively inflexible plastic elements. Since the manufacture of smart labels must take place in high numbers per unit time, not only the manufacturing speed but also the production costs incurred in connection with a mass-produced product are important factors for the more efficient production of smart labels.

Material costs can be reduced for example by the use of silicon chips of small dimensions. However, this necessarily gives rise to smaller dimensions of connection elements of the chips/chip modules, which in turn make it more difficult to precisely position these connection elements on the connection elements of the antenna element of a subsequent smart label. This also results in a reduction in the speed of mounting the chip module on the antenna substrate and the connection elements of the antenna element, and also in a reduction in item numbers per unit time, since the highly precise positioning of the chip modules requires that the operating steps be slowed down.

Usually, in the manufacture of smart labels, RFID chips are applied to the antenna substrates by means of pick-and-place methods in a conventional flip-chip technique. In this case, a high-precision robot removes a silicon chip from a wafer and rotates it through 180° in order then to mount it upside-down on the antenna substrate. During this mounting operation, extremely small connection surfaces of the connection elements of the chip must be brought with very high precision into a position corresponding to the connection elements of the antenna.

However, since the connection elements of the antenna element are usually located on wide and flexible webs—typically having a width of around 500 mm—with the antenna substrates, precise positioning of the chip in an order of magnitude of around 10-20 μm within such a large operating field is possible only with high costs for the robot technology and with an increased outlay in terms of time. Accordingly, such mounting devices are relatively slow in terms of their operation and cannot be used for any small chip size.

In order to overcome the mounting problem in the case of chips/chip modules of small dimensions, use is made of module bridges which have the function of forming conductive connections in the manner of a bridge from the connection elements of the chip module to the larger connection elements of the antenna element on the antenna substrate. Such module bridges are frequently known as individual plastic elements which give rise to additional costs in terms of manufacture and material. In this way, highly precise positioning of the chip modules within a small operating field is carried out in such a way that the chip modules are firstly arranged on the module bridges for example by means of pick-and-place methods. The individual module bridges are then mounted within the large operating field on the antenna substrate or the connection elements of the antenna element, with less accuracy. Mounting with reduced accuracy is possible on account of the relatively large connection elements of the antenna element and of the module bridge. Rapid mounting of the module bridge with the chip module on the antenna substrates is thus possible. However, this requires the previous separate manufacture of cost-intensive module bridges and, in a further step, the connection of the chip modules to the module bridges in order then to be able to carry out the final mounting of these components on the antenna substrate.

Also known is a production method for smart labels in which an RFID chip is shaken from a shaker onto the antenna substrate. A method is also known in which a chip of special geometry which is suspended in a liquid is poured into suitably designed cavities. Both methods require a special and in some cases complicated chip design, which limits their use to certain chip types and manufacturers.

Accordingly, the object of the present invention is to provide a method for producing module bridges for smart labels, which permits the cost-effective, rapid and simple production of smart labels.

This object is achieved according to the features of claim 1.

One essential point of the invention is that, in a method for producing module bridges for smart labels for positioning chip modules on carriers and for the bridging, conductive connection of connection elements of the chip modules to connection elements of antenna elements arranged on or in the carriers, the following steps are carried out:

forming depressions arranged one behind the other within an endless carrier strip which can be moved in the longitudinal direction;

positioning a respective chip module in each depression with connection elements pointing upwards; and

applying strip-like contact layers to the connection elements of the chip modules and a surface of the carrier strip next to the depressions, so as to form enlarged contact areas.

In addition, either strip-like adhesive layers are applied to the contact layers or the contact layers themselves are designed as adhesive layers. In the latter case, the contact layers may consist either of prepolymerized epoxy resin with conductive particles contained therein or of a hot-melt adhesive with conductive particles contained therein.

By virtue of the use of an endless carrier strip, on which a plurality of module bridges are formed in a manner arranged one behind the other, a rapid and simple sequential procedure is possible when producing such module bridges. In particular, according to the invention, the simple arrangement of individual chip modules in depressions arranged one behind the other and the application over these of the strip-like contact layers which have larger surface areas than the connection elements of the chip modules, allows the production of a large number of module bridges within a short time.

Such module bridges of simple design moreover advantageously have low material and production costs.

According to one preferred embodiment, a liquid adhesive is filled into a depression in a predefined amount prior to the positioning of the chip module in this depression, and is cured by means of UV, electron and/or thermal irradiation following the step of positioning the chip module. This permits simple and rapid fixing of each chip module within the depressions.

The chip modules are preferably positioned within the depressions in such a way that their upper sides and the surface of the carrier strip lie in a substantially common plane. In this way, the contact layers to be arranged over the upper side and the surface are formed in one piece without the risk of forming recesses or steps.

The contact layers are ideally designed as a first strip-like contact layer which extends in the longitudinal direction of the carrier strip and covers the first connection elements of first connection sides of the chip modules, and as a second strip-like contact layer which extends in the longitudinal direction of the carrier strip and covers the second connection elements of second connection sides of the chip modules. Such strip-like contact layers are continuously printed on for example in a screen printing method or an inkjet printing method while the carrier strip continues to move in the longitudinal direction of the carrier strip. This permits the rapid and simple formation of enlarged contact areas for a large number of chip modules.

The contact layers may consist of a conductive silver paste or some other conductive material which can be applied and cured.

The adhesive layers are also preferably printed on as two preferably conductive adhesive layers which run parallel to one another in the longitudinal direction of the carrier strip. The adhesive layers, which serve for mechanical and/or electrical connection to an antenna substrate, can also be applied continuously during further transport of the carrier strip. Possible electrically conductive adhesives for use here are hot-melt adhesives which are tacky when hot and solidify upon cooling.

According to one preferred embodiment, slots which extend in the width direction of the carrier strip are punched out between the depressions in the carrier strip at the start of the method, in order to allow subsequent separation of this module bridge composite by cutting the composite in the longitudinal direction of the carrier strip. As an alternative to cutting in the longitudinal direction of the carrier strip, half-webs which lie on a common line with the slots can be cut through rapidly in the transverse direction of the carrier strip, in order to obtain separation.

Such a separation of the module bridges can be carried out by means of a compact, cassette-type device in which the module bridges are dissolved out of the endless carrier strip at a speed V1, accelerated and mounted in a preferably continuous manner on the antenna substrate at the speed V2. In this way, the separation and mounting of the module bridges arranged on the endless carrier strip is possible in a rapid and continuous method.

Both the strip-like contact layers and the strip-like adhesive layers have interruptions which run in a manner corresponding to the slots in the carrier strip, said interruptions being produced automatically during the printing process due to the presence of the slots. Subsequent separation of the module bridges is thus possible without damaging the layers.

The material of the carrier strip is cost-effective and is a plastics and/or paper material. Such materials can be shaped three-dimensionally in a simple and rapid manner by employing known shaping techniques, such as thermoplastic deformation, stamping or punching for example. By using an appropriate tool, the shape of the depressions can be configured in such a way that said depressions are designed to be complementary to the outer shape of the chip module received therein. This results in better fixing of the chip module within the depression.

Alternatively, depressions can be used which allow chip modules of various surface structures to be arranged therein. Versatile use of the production method according to the invention is thus possible.

Following the shaping of the depressions, the carrier strip is preferably perforated along its edges by means of a punching process, so that rows of holes exist for the engagement of transport elements.

The depressions may be provided with punched holes, on which the chip module comes to rest. Such punched holes can advantageously be used for a subsequent curing operation for the adhesive arranged therein, due to the direct access to the adhesive.

Further embodiments emerge from the dependent claims.

Advantages and expedient features can be found from the following description in conjunction with the drawing, in which:

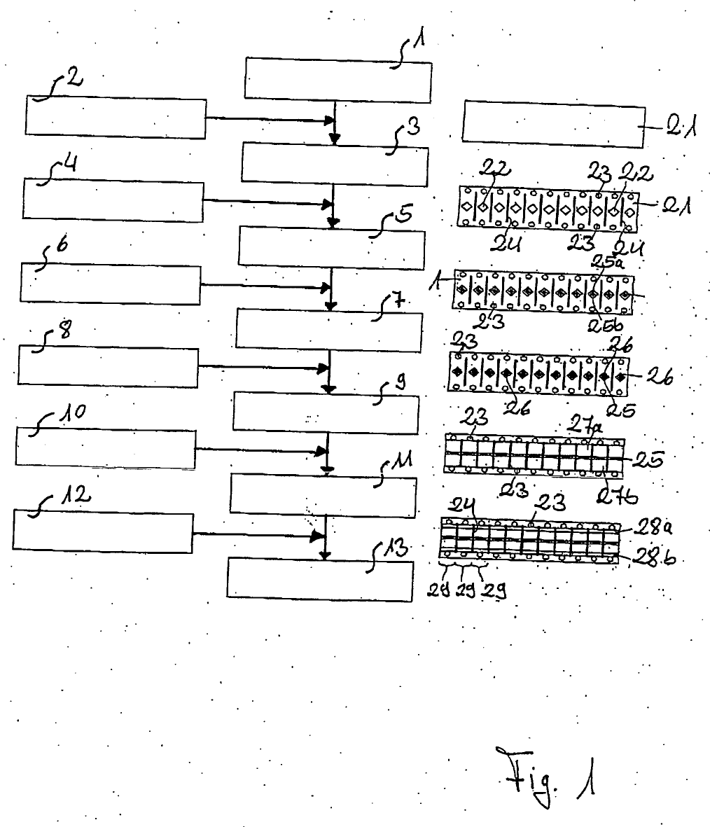

FIG. 1 shows, in a schematic block diagram, the method according to the invention for producing module bridges; and

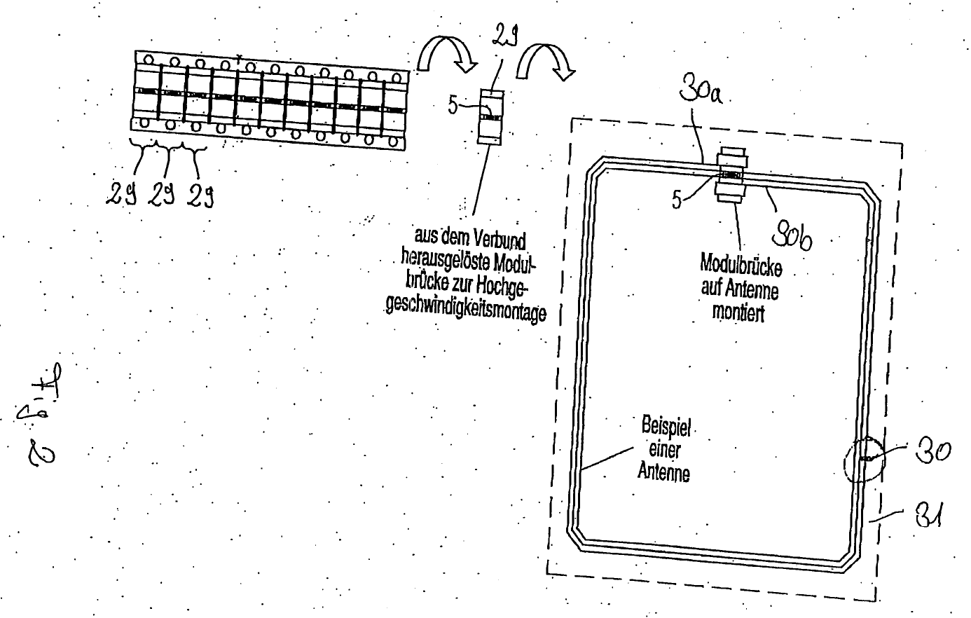

FIG. 2 shows, in a simplified schematic plan view, the positioning of an individual module bridge on an antenna substrate.

FIG. 1 shows in a simplified manner, in a block diagram, the procedure of the production method according to the invention. In a first step 1, there is a carrier strip made of plastic or paper. In a second step 2, the carrier strip is shaped, for example by means of thermoplastic deformation, stamping or punching. There is now a three-dimensional shaped carrier strip with depressions arranged one behind the other (step 3).

Step 4 comprises the positioning of the chip modules within the depressions, said depressions already being filled with a predefined amount of adhesive. To this end, each chip module is removed from a wafer and inserted in a depression (step 5).

In steps 6 and 7, the chip modules are fixed by curing the adhesives by means of UV, electron and/or thermal irradiation. It should be ensured that an upper side of the chip modules lies in a common plane with the surface of the carrier strip.

In steps 8 and 9, in order to form enlarged contact connections, a conductive silver paste is printed as contact layers onto the connection elements of the chip modules and the surface of the carrier strip which surrounds the depressions.

Two strip-like adhesive strips which run parallel to one another are then printed on, these being designed for mechanical and/or electrical subsequent connection to the connection elements of the antenna element.

In steps 12 and 13, the module bridges contained in a composite are separated for example by means of a cassette-type device, in order then to be arranged individually on an antenna substrate.

In order to receive the chip modules, firstly the depressions 22 are arranged one behind the other in the carrier strip 21 by means of a stamping operation. At the same time, rows of holes 23 are punched out at the edges of the carrier strip 21, along with slots 24 which extend between the depressions 22 in the width direction of the carrier strip.

Once the chip modules 25 have been inserted with first and second connection sides 25a, 25b in the depressions 22, the adhesive 26 which is also arranged in the depressions is then cured so as to durably fix the chip modules 25 within the depressions 22.

The contact layers 27a and 27b extend in a strip-like manner and run parallel to one another, respectively over the first connection sides 25a of the chip modules 25 and the second connection sides 25b of the chip modules 25.

The adhesive layers 28a and 28b printed onto the contact layers 27a and 27b are arranged in a strip-like manner thereon, in order to obtain an adhesive connection to the antenna substrate or the connection elements of the antenna element.

The endless carrier strip, part of which is shown in this diagram, comprises a large number of module bridges 29 arranged one behind the other.

The schematic diagram of FIG. 2 shows, in a plan view, the positioning of individual module bridges 29, including the chip modules 25 associated therewith, on the antenna element 30. In this case, the antenna element is arranged on the antenna substrate 31, as shown schematically.

The antenna element 30 has connection elements 30a and 30b which come into contact with the upper and lower contact layers 27a and 27b when the module bridge 29 is mounted. To this end, the module bridge is adhesively bonded onto the antenna substrate by means of the strip-like adhesive layers 28a and 28b.

A mounting operation taking place in this way can be carried out at high speed since both the contact layers 27a and 27b and the connection elements of the antenna element 30 are relatively large and accordingly require less accurate positioning of the module bridge.

All the components and features are to be considered essential to the invention.

### LIST OF REFERENCES

1 provision of the carrier strip

2 shaping of the carrier strip

3 presence of the shaped carrier strip

4 placement of the chip module within the deposit of adhesive

5 presence of the carrier strip with the placed chip modules

6 fixing of the chip module with curing of the adhesive

7 presence of the fixed chip modules with small height differences with respect to the surface of the carrier strip

8 contacting of the chip module connection elements

9 presence of enlarged contact connection elements

10 application of the adhesive layers

11 presence of finished module bridges

12 separation of the module bridges

13 mounted module bridges on the antenna substrate

21 carrier strip

22 depressions

23 rows of holes

24 slots

25 chip modules

25a first connection side of the chip modules

25b second connection side of the chip modules

26 adhesive

27a, 27b contact layers

28b, 28b adhesive layers

29 module bridges

30 antenna, antenna element

30a, 30b connection elements of the antenna element

31 antenna substrate

1. Method for producing module bridges (29) for smart labels, for positioning chip modules (25) on carriers (31) and for the bridging, conductive connection of connection elements of the chip modules (25) to connection elements (30a, 30b) of antenna elements (30) arranged on or in the carriers (31), the method comprising:
forming (2) depressions (22) arranged one behind the other within a carrier strip (21) which can be moved in the longitudinal direction;
positioning (4) a respective chip module (25) in each depression (22) with connection elements pointing upwards; and
printing (8) strip-like contact layers (27a, 27b) to the connection elements of the chip modules (25) and a surface of the carrier strip (21) next to the depressions (22), so as to form enlarged contact areas.

2. Method according to claim 1, further comprising:
applying (10) strip-like adhesive layers (28a, 28b) to the contact layers (27a, 27b).

3. Method according to claim 1, wherein
the contact layers (27a, 27b) are designed to be self-adhesive.

4. Method according to any of claim 1, further comprising:
filling one or more of the depressions (22) with a liquid adhesive (26) in a predefined amount prior to the positioning (4) of the chip module (25).

5. Method according to claim 4, wherein
the liquid adhesive (26) is cured (6) following positioning of the chip module (25).

6. Method according to claim 5, wherein
the curing (6) of the adhesive (26) is carried out by at least one of UV, electron and/or thermal irradiation.

7. Method according to claim 1, wherein
positioning includes positioning the chip modules (25) within the depressions (22) in such a way that upper sides of the chip modules (25) and the surface of the carrier strip (21) lie in a substantially common plane.

8. Method according to claim 1, wherein
the contact layers (27a, 27b) are printed on as include a first strip-like contact layer (27a) which extends in the longitudinal direction of the carrier strip and covers first connection elements of first connection sides (25a) of the chip modules (25), and as a second strip-like contact layer which extends in the longitudinal direction of the carrier strip and covers the second connection elements of second connection sides (25b) of the chip modules (25).

9. Method according to claim 2,
the strip-like adhesive layers (28a, 28b) are conductive adhesive layers which run parallel to one another in the longitudinal direction of the carrier strip.

10. (canceled)

11. (canceled)

12. Method according to claim 1, further comprising:
punching rows of holes (23) for the engagement of transport elements at the edge of the carrier strip (21).

13. Method according to claim 1,
the depressions (22) are provided with at least one punched hole.

14. Method according to claim 1,
the carrier belt (21) is one or more of moved continuously or stopped temporarily in its longitudinal direction during the aforementioned method steps.

15. Method according to claim 2, further comprising:
punching slots (24) in the carrier strip between the depressions (22), the slots are substantially perpendicular to the longitudinal direction of the carrier strip.

16. Method according to claim 15, further comprising
interrupting the printing of the contact layers (27a, 27b, 28a, 28b), the interruptions are approximately parallel to the slots.
